(19) United States
(12) Patent Application Publication
(10) Pub. No.: US 2010/0286917 A1
(43) Pub. Date: Nov. 11, 2010

(54) METHOD AND SYSTEM FOR REPRESENTING WELLS IN MODELING A PHYSICAL FLUID RESERVOIR

(76) Inventors: RANDY DOYLE HAZLETT, DALLAS, TX (US); DESARAZU KRISHNA BABU, ADDISON, TX (US)

Correspondence Address: Potential Research Solutions, 1818 Shelmire Dr, Dallas, TX, 75224, US

(21) Appl. No.: 12/436,779

(22) Filed: May 7, 2009

(51) Int. Cl. G01V 1/40

(52) U.S. Cl. 702/12

(57) ABSTRACT

The disclosure is directed to a method of representing fluid flow response to imposed conditions in a physical fluid reservoir through wells. The invention utilizes techniques and formulas of unprecedented accuracy and speed for computations for a fundamental element in analysis of fluid movement through subterranean reservoirs—the calculation of Green's and Neumann functions in finite three-dimensional space. The method includes modeling of pressure and/or flow rate observables at wells in said reservoir using an easily computable, closed-form Green's or Neumann function for a linear well segment in arbitrary orientation within a three dimensional cell of spatially invariant but anisotropic permeability. The method further includes the modeling of fluid flow in the physical fluid reservoir with an assemblage of linear well segments operating in unison with uniform flux density to represent arbitrary well trajectory. The method further includes modeling reservoir flow through one or more linear well segments of non-uniform flux related by a constitutive expression linking pressure distribution and flow rate within the well. The method further includes generalization through integration of easily computable Green's or Neumann functions to represent fractures or fractured wells in modeling fluid flow in a physical reservoir. The system includes modeling fluid flow through a mesh representation of the physical fluid reservoir containing one or more wells represented by easily computable Green's or Neumann functions. The system further includes modeling of flow in the physical reservoir via a numerical method in which the values of pressure and flux assigned to the mesh are related to observables at the well using aforementioned easily computable Green's or Neumann functions. The system further includes the coupling of well and mesh values within the numerical solution method for well observation or feedback control. The system still further includes the localization of the well model to the properties assigned to only those mesh elements penetrated by the well using boundary integral equation methods. The invention also incorporates the addition of transients in fluid flow towards a steady or pseudo-steady state, and use thereof, in the above constructs.

### REFERENCE TO RELATED APPLICATIONS

Not Applicable

### ACKNOWLEDGMENT OF GOVERNMENT SUPPORT

Not Applicable

### COMPACT DISC APPENDIX

Not Applicable

### BACKGROUND OF THE INVENTION

1. Field of the Invention

The invention pertains to the field of oil and gas well productivity modeling, and more particularly, to modeling the relationship between pressure gradient and fluid flux for the well and the surrounding hydrocarbon reservoir. More specifically, the invention relates to well productivity modeling for advanced well designs and to well connections for complex wells in numerical reservoir simulation methods.

2. Description of Related Art

The field of reservoir engineering includes modeling the capacity of wells to inject or withdraw fluids and the sustainability of production rates. The finite size and shape of hydrocarbon reservoirs dictates the long term relationship between withdrawal rate and pressure decline. Well equations try to capture this relationship for the dominant time period of well operation, known as the pseudo-steady state regime, as a function of reservoir characteristics and well properties, such as well radius and well location. Well equations are traditionally constructed for single phase flow and suitably modified through introduction of empirical relative permeability concepts for multiphase flow use. With adequate well models, numerical reservoir simulation is used to place wells optimally (U.S. Pat. No. 7,181,380).

Early use of well equations was based upon mathematical solutions to the governing equations, but these were amenable for only the simplest of reservoir descriptions and well configurations. The industry turned to numerical methods and computers to solve the governing equations with more complex inputs. Examples of such simulation methods are found in U.S. Pat. No. 7,369,973, U.S. Pat. No. 7,324,929, U.S. Pat. No. 6,810,370, and U.S. Pat. No. 7,289,942. However, the physical size of a wellbore, nominally 6 inches, is far below the resolution of most numerical reservoir simulations. As such, the industry relies upon so-called well equations to relate the properties of a reservoir grid cell to observables, i.e. pressure and flow rate, for a well within the cell. Well equations, pioneered by Peaceman (1978, 1983), were constructed from fine scale numerical simulations for use at the practical scale, and as such, entertained only a small subset of possible configurations. In order to capture smaller scale effects, some practitioners use local grid refinement around wells (U.S. Pat. No. 6,907,392, U.S. Pat. No. 7,047,165, U.S. Pat. No. 7,451,066, U.S. Pat. No. 6,078,869, U.S. Pat. No. 6,018,497), dramatically increasing the computational overhead with greater risk of problem numerical stability.

The application of horizontal drilling technology made the prior set of well equation rules obsolete, as hydrocarbon reservoirs are typically laterally extensive but thin. The proximity of reservoir boundaries in horizontal wells required new relationships. The industry returned to mathematical solutions of the governing equations to redefine well equations. While breakthroughs in modeling were found, this next generation of mathematical solutions was not without limitations regarding complexity of reservoir description and allowed well configurations. Prior art (Babu and Odeh, 1989) restricted the solution to the case where the well was aligned with a coordinate axis. As such, solutions were restricted to purely horizontal or vertical wells, and not the general slanted well of arbitrary inclination. Slanted wells were approximated by stair-step assembly of horizontal and vertical segments or by restricting well orientation (Jasti, Penmatcha, and Babu, 1999). These equations also applied to the reservoir as a whole and could be localized for use in simulations only for uniform numerical grids in a homogeneous reservoir (Babu et al., 1991). Furthermore, the computational time can be a burden in numerical schemes for certain sets of input parameters (Aavatsmark and Klausen, 2003). As mathematical solutions to differential equations, the models are specific to boundary conditions imposed at the physical limits to the reservoir. The boundary condition most often imposed is that of a sealed system; however, many reservoirs have leaky sides through which the influx of water is possible, resulting in delayed pressure decline. Older models exist for so-called bottom and edge water drive mechanisms; however, there is a need to account for these options in advanced models. The industry typically defers to numerical simulation methods to incorporate these effects locally rather than globally. The restriction of analytic solutions to homogeneous systems has been somewhat overcome through the use of boundary integral methods to solve for pressure in a piece-wise homogeneous fashion (Hazlett and Babu, 2005). Still, prior art using semi-analytical solutions did not entirely replace the older Peaceman-type methods using empirical well connections. Others, (Aavatsmark & Klausen, 2003; Wolfsteiner et al., 2003), have developed well equations for nonconventional wells based upon analytic solutions for infinite homogeneous systems and incorporated these into numerical schemes, but the proximity of boundaries and reservoir heterogeneity will lead to undesirable error.

There is a need for simple analytic productivity equations which can model the entire reservoir for different combinations of boundary conditions. It would be highly desirable to have a well productivity model which could quickly and accurately model pressure and flow rate for an arbitrary number of wells of arbitrary trajectory or of complex, multiple wellbore configuration for various imposed reservoir boundary conditions.

There is further need to embed a fast-computing, accurate well equation in a numerical reservoir simulation capable of modeling wells of arbitrary trajectory or of complex, multiple wellbore configuration below the resolution of the simulation. It would be highly desirable to have such a well productivity model which could restrict attention locally to the cell containing the well without loss of generality or accuracy.

### SUMMARY OF THE INVENTION

The invention comprises the reduction of a generalized equation describing the productivity of an arbitrarily oriented well segment within a subterranean fluid reservoir to a readily useable form and subsequent use of this new formula to accomplish new tasks, such as, but not limited to, productivity modeling of wells of arbitrary trajectory, including those with multiple intersecting wellbores. The invention also encompasses the interlacing of the new well equation in numerical reservoir simulators with wells below the resolution of the grid system used to define the reservoir size, shape, and heterogeneous property distribution. The invention is capable of accurately modeling multiple wells simultaneously with sealed boundaries or with permeable boundaries through use of boundary integral equations. The invention is robust and adaptable to well constraints on either flux or pressure. The invention applies also to two-dimensional simulation in thin reservoirs where horizontal and slanted wellbores behave as vertical, fully penetrating fractures with the orientation of their projections onto the XY plane. The invention represents an unprecedented level of accuracy and flexibility in modeling wells with significant time savings over prior art in the combined use of purely analytic and highly accurate approximations to rapidly convergent infinite series summations. At the computational level, the derived formulas are characterized by either polynomial expressions or exponentially-damped infinite series.

### BRIEF DESCRIPTION OF THE DRAWINGS

FIG. 1 shows a schematic of a line source inside a three-dimensional box of dimensions a, b, and h with endpoints (x₁, y₁, z₁) and (x₂, y₂, z₂), length, L, and direction cosines (α, β, γ).

FIG. 2 shows the dimensionless pressure distribution,

$$\tilde{P} ( x , y , z ) ≡ \frac{( P ( x , y , z ) - \overline{P} ) abh}{4 π B μ q} , within$$

a unit cube of isotropic permeability for an XZ slice containing a well represented by a uniform flux line source with well endpoints (x₁, y₁, z₁)=(0.25, 0.50, 0.25) and (x₂, y₂, z₂)=(0.75, 0.50, 0.75): (a) Partially penetrating well configuration, and (b) Pressure distribution for the XZ plane containing the well shown with a banded look-up table in order to easily visualize isopotential contours.

FIG. 3 shows a line source from (x₁, y₁, z₁) to (x₂, y₂, z₂) indicating the midpoint where the well pressure is typically evaluated along the locus of points on the plane normal to the well axis at a physical distance r_{w}, the well radius, from the mathematical source.

FIG. 4 shows an example of pressure computation for a well configuration within a unit cube leading to nonsymmetric isopotential surfaces normal to the well: (a) Partially penetrating well configuration, and (b) Pressure distribution for the XZ plane normal to the well at the midpoint, (c) Pressure distribution for the YZ plane containing the well, and (d) A close-up view of the pressure distribution in the immediate vicinity of the mathematical line source indicating a loss of symmetry as a function of radius and variation in pressure at the well radius, r_{w}, as a function of position using r_{w}/a=0.015.

FIG. 5 shows XY planar slices of dimensionless pressure at different elevations through a cubic cell of homogeneous permeability in which a multilateral well with a motherbore and four laterals in the configuration shown in the schematic, demonstrating the capability of modeling advanced wells. In this example, the flux per unit of well length is held constant.

FIG. 6 shows a multi-segmented well illustrating the construction of differential pressure constraints along the length of a well and relationships imposed. Each segment is characterized by the pressure at the midpoint at the well radius and an average flux in this piecewise uniform flux model. The internal flow rate increases progressively, starting from the tip in a production well, while the pressure drop between segments is a function of the Reynolds Number, N_{Re}, and a wall roughness parameter.

FIG. 7 shows the pressure distribution resulting from production through an advanced well forming a curved pathway within a homogeneous, 3D, cubic medium in which the well is composed of 29 adjoining, piecewise linear segments with either constant flux or constant pressure imposed at a chosen well radius (r_{w}/a=0.00015) at the segment midpoints and graphs depicting the flux and pressure at those locations as a function of progressive length down the well: (a) Well configuration within the cell, (b) Central XZ slice through the computed pressure field for the plane containing the well with imposed uniform flux, (c) Central XZ slice through the computed pressure field for the plane containing the well with imposed uniform pressure, (d) Plot of pressure and flux as a function of cumulative well length for the uniform flux case, and (e) Plot of pressure and flux as a function of cumulative well length for the uniform pressure case.

FIG. 8 shows a rectangular cell containing a line source representing a well from (x₁, y₁, z₁) to (x₂, y₂, z₂), an observation point, which is typically a location at the reservoir sandface, and the six external faces upon which a single value of flux is ascribed. Note the z values increase downward in accordance with industry standards, and all outward normal fluxes are defined as positive, as conventional in mathematics.

FIG. 9 shows three-dimensional plots of pressure for the same curvilinear well trajectory as in the constant pressure case of FIG. 7 with various combinations of open and closed boundaries: (a) the sealed boundary case in which the medium behaves as a volume-distributed source, supplying fluid to the well through fluid expansion as the average cell pressure declines, (b) the case with uniform flux on two lateral faces, each supplying half the well production, and (c) the case with uniform flux from the bottom face supplying the full well production. The choice of banded lookup table allows easy visualization of isopotential surfaces. Note that isopotential surfaces intersect sealed boundaries at right angles. The flux density weighted average pressure at a prescribed well radius is given as an annotation, indicating sensitivity of well observations to external boundary conditions.

### DETAILED DESCRIPTION OF THE INVENTION

The invention pertains to solutions to the three-dimensional Poisson's equation, given in a Cartesian coordinate system as

$${k}_{x} \frac{{\partial }^{2} u}{\partial {x}^{2}} + {k}_{y} \frac{{\partial }^{2} u}{\partial {y}^{2}} + {k}_{z} \frac{{\partial }^{2} u}{\partial {z}^{2}} = - f ( x , y , z ; {x}_{o} , {y}_{o} , {z}_{o} ) . \qquad ( 1 )$$

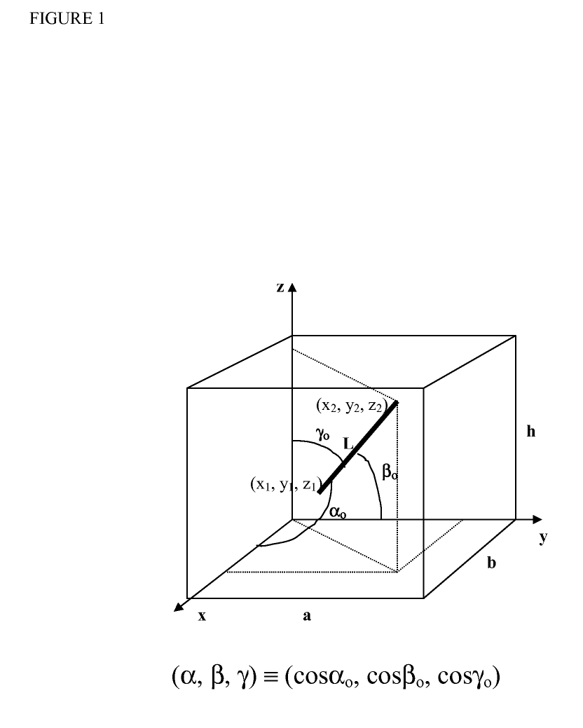

Here, (kₓ, k_{y}, k_{z}) denote the directional permeabilities of the medium through which fluid moves, and the right-hand side (RHS) indicates a source or sink. In particular, this invention pertains to a fast method to compute the solution for a line source term representing a well with arbitrary three-dimensional orientation within a sealed, rectangular, box-shaped cell. The computation is further generalized to represent a cell of spatially invariant properties within a larger heterogeneous reservoir system decomposed into intercommunicating blocks. The source is represented by a straight line of length L, with endpoints (x₁, y₁, z₁) and (x₂, y₂, z₂), located within the box as illustrated in FIG. 1. Let the direction cosines of this line be (α, β, γ), so that (Lα, Lβ, Lγ)=≡[(x₂−x₁), (y₂−y₁), (z₂−z₁)]. Points on this line source are represented parametrically,

(x₀,y₀,z₀)≡[(x₁+αs),(y₁+βs),(z₁+γs), 0≦s≦s—L], (2)

where the parameter “s” measures the distance along its length from one end. In terms of the Dirac delta function, δ, the RHS source term is represented as

f(x,y,z;x₀,y₀,z₀)˜δ(x−x₀)·δ(y−y₀)·δ(z−z₀) (3)

The solution of Equation (1) for potential and Neumann (zero flux) boundary conditions is given by integration of the point source solution along the path defined by Equation (2). Potential is interpreted as pressure once gravitational forces are included.

$$\begin{matrix}P ( \begin{matrix}x , y , z ; {x}_{1} , {y}_{1} , \\ {z}_{1} ; α , β , γ ; L\end{matrix} ) - \overline{P} = ( \frac{C}{L} ) {\int }_{0}^{L} [ \begin{matrix}( {S}_{XYZ} + {S}_{YZ} ) + \\ ( {S}_{XZ} + {S}_{Z} ) + \\ ( {S}_{XY} + {S}_{Y} ) + {S}_{X}\end{matrix} ] d s & ( 4 ) \\ where C = ( \frac{4 π B μ q}{abh} ) & ( 5 )\end{matrix}$$

P̅ is the spatial average pressure, B is a volume correction factor for the fluid, since standard practice is to cite the production rate at surface conditions, μ is the fluid viscosity, q is the volumetric production rate, and a, b, and h are the box dimensions. If standard engineering units are used, i.e. viscosity in centipoises, production rate in barrels per day, permeability in millidarcies, pressure in psi, and lengths in feet, a conversion factor of

$$70.6 \frac{day \cdot {ft}^{3} \cdot md}{cp \cdot bbl}$$

is required to reconcile units. On the RHS of Equation (4), the point source solution consists of one triple infinite series (S_{XYZ}), three double infinite series, (S_{XY}, S_{YX}, S_{YZ}), and three single infinite series (S_{X}, S_{Y}, S_{Z}). The triple infinite series, S_{XYZ}, is given as

$${S}_{XYZ} = ( \frac{8}{{π}^{2}} ) {\sum }_{t , m , n = 1}^{∞} \frac{cos ( \frac{π lx}{a} ) cos ( \frac{π my}{b} ) cos ( \frac{π nz}{h} ) cos ( \frac{π {lx}_{{ }_{o}}}{a} ) cos ( \frac{π {my}_{o}}{b} ) cos ( \frac{π {nz}_{{ }_{o}}}{h} )}{{{k}_{x} ( \begin{matrix}l \\ a\end{matrix} )}^{2} + {{k}_{y} ( \begin{matrix}m \\ b\end{matrix} )}^{2} + {{k}_{z} ( \begin{matrix}n \\ h\end{matrix} )}^{2}} \qquad ( 6 )$$

The double infinite series, S_{YZ}, is given as

$${S}_{YZ} = ( \frac{4}{{π}^{2}} ) {\sum }_{m , n = 1}^{∞} \frac{cos ( \frac{π my}{b} ) cos ( \frac{π nz}{h} ) cos ( \frac{π {my}_{o}}{b} ) cos ( \frac{π {nz}_{o}}{h} )}{{{k}_{y} ( \frac{m}{b} )}^{2} + {{k}_{z} ( \frac{n}{h} )}^{2}} \qquad ( 7 )$$

Analogous series S_{XY} and S_{XZ} are obtained by change of variables. The single infinite series, S_{X}, is given as

$${S}_{X} = ( \frac{2}{{π}^{2}} ) {\sum }_{l = 1}^{∞} \frac{cos ( \frac{π lx}{a} ) cos ( \frac{π {lx}_{o}}{a} )}{{{k}_{x} ( \frac{l}{a} )}^{2}} \qquad ( 8 )$$

Analogous series S_{Y} and S_{Z} are obtained by change of variables.

The invention is not the delineation of Equation (4), but rather the reduction of these very slowly converging triple and double infinite series to readily computable parts for practical application. Any source term in Equation (4) without a dependency upon the integration parameter, s, is recognized as a trivial case, e.g. a well aligned with a principal axis, and is covered by developments in the public domain. The preferred embodiment of this invention would screen out the special cases where alternate computation schemes are advantageous, though these situations are tractable with the general formulas given, provided routine precautions are taken to avoid fatal computational errors, such as division by zero. For completeness, guidance regarding alternate schemes for these special cases is provided in a later section. The complementary solution with Dirichlet (constant pressure) boundary conditions is recovered by replacing all cosine terms with sine counterparts. Constant pressure conditions are especially relevant to cases of strong aquifer (large connected water reservoir) pressure support of hydrocarbon reservoirs. The Neumann case is further generalized herein to include material transport into or out of the cell through use of Green's Theorem and boundary integral equations.

### Development

For ease of notation, we divide the integral in Equation (4) into subintegrals.

P(x,y,z;x₁,y₁,z₁;α,β,γ,L)− P̅=C[(I_{XYZ}+I_{YZ})+(I_{XZ}+I_{Z})+(I_{XY}+I_{Y})+I_{X}] (9)

The grouping of terms recognizes that certain expressions developed will contain lower dimensional series, eliminating the need for separate computations.

### Integrated Triple Infinite Series (I_{XYZ})

Beginning with the most complicated term of Equation (9), I_{XYZ}, from Equations (2), (4), and (6), we have

$$\begin{matrix}{I}_{XYZ} ≡ \frac{1}{L} {\int }_{s = 0}^{L} {S}_{XYZ} d s \\ = ( \frac{8}{{π}^{2} L} ) {\int }_{0}^{L} {\sum }_{l , m , n = 1}^{∞} \frac{\begin{matrix}cos ( \frac{π lx}{a} ) cos ( \frac{π my}{b} ) cos ( \frac{π nz}{h} ) \\ cos ( \frac{π {lx}_{o}}{a} ) cos ( \frac{π {my}_{o}}{b} ) cos ( \frac{π {nz}_{0}}{h} )\end{matrix}}{{{k}_{x} ( \frac{l}{a} )}^{2} + {{k}_{y} ( \frac{m}{b} )}^{2} + {{k}_{z} ( \frac{n}{h} )}^{2}} d s\end{matrix} \qquad ( 10 )$$

Next we reduce the triple series to a double series and then integrate with respect to s. Rearranging and using the identity, 2 cos A cos B=cos(A+B)+cos(A−B),

$${I}_{XYZ} = ( \frac{4}{{π}^{2} L} ) {\int }_{0}^{L} {\sum }_{m , n = 1}^{∞} \{ \begin{matrix}\frac{cos ( \frac{π my}{b} ) cos ( \frac{π nz}{h} ) cos ( \frac{π {my}_{o}}{b} ) cos ( \frac{π {nz}_{o}}{h} )}{\frac{{k}_{x}}{{a}^{2}}} \cdot \\ {\sum }_{i = 1}^{∞} \frac{[ cos ( \frac{π l ( x + {x}_{o} )}{a} ) + cos ( \frac{π l ( x - {x}_{o} )}{a} ) ]}{{l}^{2} + {a}^{2} [ \frac{{k}_{y}}{{k}_{x}} {( \frac{m}{b} )}^{2} + \frac{{k}_{z}}{{k}_{x}} {( \frac{n}{h} )}^{2} ]}\end{matrix} \} d s \qquad ( 11 )$$

Applying the identity,

$${\sum }_{n = 1}^{∞} \frac{cos ( π nz )}{{n}^{2} + {β}^{2}} = ( \frac{π}{2 β} ) \frac{cosh [ π β ( 1 - z ) ]}{sinh ( πβ )} - \frac{1}{2 {β}^{2}} ,$$

0≦z≦2, and rewriting the hyperbolic functions in their exponential forms, we get

$${I}_{XYZ} = ( \frac{4}{{π}^{2} L} ) \\ {\int }_{0}^{L} \{ \begin{matrix}( \frac{π a}{2 {k}_{x}} ) \cdot {\sum }_{m , n = 1}^{∞} \frac{cos ( \frac{π my}{b} ) cos ( \frac{π nz}{h} ) cos ( \frac{π {my}_{o}}{b} ) cos ( \frac{π {nz}_{o}}{h} )}{( 1 - {e}^{- 2 π a} \sqrt{\frac{{k}_{y} {m}^{2}}{{k}_{x} {b}^{2}} + \frac{{k}_{z} {n}^{2}}{{k}_{x} {h}^{2}}} ) \sqrt{\frac{{k}_{y}}{{k}_{x}} \frac{{m}^{2}}{{b}^{2}} + \frac{{k}_{z}}{{k}_{x}} \frac{{n}^{2}}{{h}^{2}}}} \\ ( \begin{matrix}{e}^{- π \sqrt{\frac{{k}_{y}}{{k}_{x}} \frac{{m}^{2}}{{b}^{2}} + \frac{{k}_{z} {n}^{2}}{{k}_{x} {h}^{2}}} \vert x \pm {x}_{o} \vert} + \\ {e}^{- π \sqrt{\frac{{k}_{y}}{{k}_{x}} \frac{{m}^{2}}{{b}^{2}} + \frac{{k}_{z} {n}^{2}}{{k}_{x} {h}^{2}}} ( 2 a - \vert x \pm {x}_{o} \vert )}\end{matrix} ) - \\ {\sum }_{m , n = 1}^{∞} \frac{cos ( \frac{π my}{b} ) cos ( \frac{π nz}{h} ) cos ( \frac{π {my}_{o}}{b} ) cos ( \frac{π {nz}_{o}}{h} )}{( {k}_{y} \frac{{m}^{2}}{{b}^{2}} + {k}_{z} \frac{{n}^{2}}{{h}^{2}} )}\end{matrix} \} d s \qquad ( 12 )$$

where the symbol “±” is used to denote the sum of two terms: one with the plus sign and the other with the minus sign. Here, the two “±” terms arise from the two cosine terms in the inner sum of Equation (11). We immediately identify the integral of second sum in Equation (12) as I_{YZ}, eliminating the need for a separate expression.
Note: If we restrict our attention to geometries with orientations such that

$$( \frac{a}{\sqrt{{k}_{x}}} ) \geq max ( \frac{b}{\sqrt{{k}_{y}}} , \frac{h}{\sqrt{{k}_{z}}} ) ,$$

we note that, for m,n=1, 2, 3,

$$max ( \begin{matrix}{e}^{- \frac{2 π am}{b}} \sqrt{\frac{{k}_{y}}{{k}_{x}}} , {e}^{- \frac{2 π an}{h}} \sqrt{\frac{{k}_{z}}{{k}_{x}}} , \\ {e}^{- 2 π a} \sqrt{\frac{{m}^{2} {k}_{y}}{{b}^{2} {k}_{x}} + \frac{{n}^{2} k}{{h}^{2} {k}_{x}}}\end{matrix} ) < {e}^{- 2 π} < 0.00187 .$$

Thus, we can drop the exponential term in the denominator of Equation (12) with no practical loss of accuracy. This allows analytical reduction of the integral. We rewrite Equation (12) as

$$\begin{matrix}( {I}_{XYZ} + {I}_{YZ} ) \approx ( \frac{a}{{π}^{2} {Lk}_{x}} ) {\sum }_{m , n = 1}^{∞} cos ( \frac{π my}{b} ) cos ( \frac{π nz}{h} ) ( {I}_{1} + {I}_{2} + {I}_{3} + {I}_{4} ) \\ where & ( 13 ) \\ {I}_{j = 1 , 4} ≡ 2 π {\int }_{s = 0}^{s = L} {E}_{j} \cdot cos [ \frac{π m}{b} ( {y}_{1} + β s ) ] cos [ \frac{π n}{h} ( {z}_{1} + γ s ) ] d s \\ or & ( 14 ) \\ {I}_{j = 1 , 4} ≡ π {\int }_{s = 0}^{s = L} {E}_{j} \cdot cos π [ ( \frac{{my}_{1}}{b} \pm \frac{{nz}_{1}}{h} ) + s ( \frac{m β}{b} \pm \frac{n γ}{h} ) ] d s & ( 15 )\end{matrix}$$

If we introduce the shorthand notation,

$$\begin{matrix}{ξ}_{k} ≡ \sqrt{\frac{{k}_{y} {m}^{2}}{{k}_{x} {b}^{2}} + \frac{{k}_{z} {n}^{2}}{{k}_{x} {h}^{2}}} , & \\ {E}_{1} ≡ \frac{1}{{ξ}_{k}} {e}^{- π ( {x}_{1} + α s + x ) {ξ}_{k}} & ( 16 ) \\ {E}_{2} ≡ \frac{1}{{ξ}_{k}} {e}^{- π [ 2 a - ( {x}_{1} + α s + x ) ] {ξ}_{k}} & ( 17 ) \\ {E}_{3} ≡ \frac{1}{{ξ}_{k}} {e}^{- π \vert {x}_{1} + α s - x \vert {ξ}_{k}} \\ and & ( 18 ) \\ {E}_{4} ≡ \frac{1}{{ξ}_{k}} {e}^{- π ( 2 a - \vert {x}_{1} + α s - x \vert ) {ξ}_{k}} & ( 19 )\end{matrix}$$

Using the identity

$$\int {e}^{at} \cdot cos ( bt ) d t ≡ \frac{{e}^{at} ( b sin ( bt ) + a cos ( bt ) )}{{a}^{2} + {b}^{2}} ,$$

we evaluate the integrals I₁, I₂, I₃, and I₄. Integration of the first two terms, I₁ and I₂, is straightforward.

$$\begin{matrix}{I}_{1} ≡ \frac{1}{{( \frac{m β}{b} \pm \frac{n γ}{h} )}^{2} + {α}^{2} {ξ}_{k}^{2}} \{ \begin{matrix}{e}^{- π ( {x}_{2} + x ) {ξ}_{k}} [ \begin{matrix}\frac{1}{{ξ}_{k}} ( \frac{m β}{b} \pm \frac{n γ}{h} ) \\ sin π ( \frac{{my}_{2}}{b} \pm \frac{{nz}_{2}}{h} ) - \\ α cos π ( \frac{{my}_{2}}{b} \pm \frac{{nz}_{2}}{h} )\end{matrix} ] - \\ {e}^{- π ( {x}_{1} + x ) {ξ}_{k}} [ \begin{matrix}\frac{1}{{ξ}_{k}} ( \frac{m β}{b} \pm \frac{n γ}{h} ) \\ sin π ( \frac{{my}_{1}}{b} \pm \frac{{nz}_{1}}{h} ) - \\ α cos π ( \frac{{my}_{1}}{b} \pm \frac{{nz}_{1}}{h} )\end{matrix} ]\end{matrix} \} & ( 20 ) \\ {I}_{2} ≡ \frac{1}{{( \frac{m β}{b} \pm \frac{n γ}{h} )}^{2} + {α}^{2} {ξ}_{k}^{2}} \{ \begin{matrix}{e}^{- π [ 2 a - ( {x}_{2} + x ) ] {ξ}_{k}} [ \begin{matrix}\frac{1}{{ξ}_{k}} ( \frac{m β}{b} \pm \frac{n γ}{h} ) \\ sin π ( \frac{{my}_{2}}{b} \pm \frac{{nz}_{2}}{h} ) + \\ α cos π ( \frac{{my}_{2}}{b} \pm \frac{{nz}_{2}}{h} )\end{matrix} ] - \\ {e}^{- π [ 2 a - ( {x}_{1} + x ) ] {ξ}_{k}} [ \begin{matrix}\frac{1}{{ξ}_{k}} ( \frac{m β}{b} \pm \frac{n γ}{h} ) \\ sin π ( \frac{{my}_{1}}{b} \pm \frac{{nz}_{1}}{h} ) + \\ α cos π ( \frac{{my}_{1}}{b} \pm \frac{{nz}_{1}}{h} )\end{matrix} ]\end{matrix} \} & ( 21 )\end{matrix}$$

Integration of I₃ and I₄ is also straightforward if x<x₁ or x>x₂. However, within the well interval x₁≦x≦x₂, the integral is split to correctly represent absolute values.

$${I}_{3} ≡ ( \frac{π}{{ξ}_{k}} ) \cdot {\int }_{s = 0}^{α s = x - {x}_{1}} {e}^{π ( {x}_{1} + α s - x ) {ξ}_{k}} \cdot cos π [ \begin{matrix}( \frac{{my}_{1}}{b} \pm \frac{{nz}_{1}}{h} ) + \\ s ( \frac{m β}{b} \pm \frac{n γ}{h} )\end{matrix} ] d s + ( \frac{π}{{ξ}_{k}} ) \cdot {\int }_{α s = x - {x}_{1}}^{α s = {x}_{2} - {x}_{1}} {e}^{π ( x - {x}_{1} - α s ) {ξ}_{k}} \cdot cos π [ \begin{matrix}( \frac{{my}_{1}}{b} \pm \frac{{nz}_{1}}{h} ) + \\ s ( \frac{m β}{b} \pm \frac{n γ}{h} )\end{matrix} ] d s \qquad ( 22 )$$

Integrating and simplifying, we obtain the general expression

$${I}_{3} ≡ \frac{1}{[ {( \frac{m β}{b} \pm \frac{n γ}{h} )}^{2} + {α}^{2} {ξ}_{k}^{2} ]} \cdot \{ \begin{matrix}H ( x - {x}_{1} ) \cdot H ( {x}_{2} - x ) \cdot 2 α cos π ( \begin{matrix}\frac{m}{b} [ {y}_{1} + \frac{β}{α} ( x - {x}_{1} ) ] \pm \\ \frac{n}{h} [ {z}_{1} + \frac{γ}{α} ( x - {x}_{1} ) ]\end{matrix} ) + \\ {e}^{- π \vert x - {x}_{2} \vert {ξ}_{k}} [ \begin{matrix}\frac{1}{{ξ}_{k}} ( \frac{m β}{b} \pm \frac{n γ}{h} ) sin π ( \frac{m}{b} {y}_{2} \pm \frac{n}{h} {z}_{2} ) + \\ α \cdot sign ( x - {x}_{2} ) cos π ( \frac{m}{b} {y}_{2} \pm \frac{n}{h} {z}_{2} )\end{matrix} ] - \\ {e}^{- π \vert x - {x}_{1} \vert {ξ}_{k}} [ \begin{matrix}\frac{1}{{ξ}_{k}} ( \frac{m β}{b} \pm \frac{n γ}{h} ) sin π ( \frac{m}{b} {y}_{1} \pm \frac{n}{h} {z}_{1} ) + \\ α \cdot sign ( x - {x}_{1} ) cos π ( \frac{m}{b} {y}_{1} \pm \frac{n}{h} {z}_{1} )\end{matrix} ]\end{matrix} \} \qquad ( 23 )$$

where the Heavyside function, H(x−xᵢ), was introduced to capture the first term only when x is within the interval, [x₁,x₂]. Following a similar approach and dropping the exponential term,

$$- \frac{\begin{matrix}H ( x - {x}_{1} ) \cdot H ( {x}_{2} - x ) \cdot 2 α \cdot {e}^{- 2 π a {ξ}_{k}} \cdot \\ cos π ( \frac{m}{b} [ {y}_{1} + \frac{β}{α} ( x - {x}_{1} ) ] \pm \frac{n}{h} [ {z}_{1} + \frac{γ}{α} ( x - {x}_{1} ) ] )\end{matrix}}{[ {( \frac{m β}{b} \pm \frac{n γ}{h} )}^{2} + {α}^{2} {ξ}_{k}^{2} ]} , \\ we get {I}_{4} . \\ {I}_{4} ≡ \frac{1}{[ {( \frac{m β}{b} \pm \frac{n γ}{h} )}^{2} + {α}^{2} {ξ}_{k}^{2} ]} \cdot \{ \begin{matrix}{e}^{- π ( 2 a - \vert x - {x}_{2} \vert ) {ξ}_{k}} [ \begin{matrix}\frac{1}{{ξ}_{k}} ( \frac{m β}{b} \pm \frac{n γ}{h} ) \\ sin π ( \frac{m}{b} {y}_{2} \pm \frac{n}{h} {z}_{2} ) + \\ α \cdot sign ( {x}_{2} - x ) \\ cos π ( \frac{m}{b} {y}_{2} \pm \frac{n}{h} {z}_{2} )\end{matrix} ] - \\ {e}^{- π ( 2 a - \vert x - {x}_{1} \vert ) {ξ}_{k}} [ \begin{matrix}\frac{1}{{ξ}_{k}} ( \frac{m β}{b} \pm \frac{n γ}{h} ) \\ sin π ( \frac{m}{b} {y}_{1} \pm \frac{n}{h} {z}_{1} ) + \\ α \cdot sign ( {x}_{1} - x ) \\ cos π ( \frac{m}{b} {y}_{1} \pm \frac{n}{h} {z}_{1} )\end{matrix} ]\end{matrix} \} \qquad ( 24 )$$

We have thus derived fast-computing formulas for the integrals, (I_{XYZ}+I_{YZ}), involving the triple infinite series (S_{XYZ}+S_{YZ}) of Equations (10) and (13), using Equations (20), (21), (23), and (24).

### Integrated Double Infinite Series (I_{XY} and I_{XZ})

Recalling I_{YZ} is exactly cancelled by a term in I_{XYZ}, we focus on the terms (I_{XY}+I_{Y}) and (I_{XZ}+I_{Z}). Fast-computing terms for the double infinite series could be accomplished by following a similar procedure; however, they can more easily be obtained as special cases of the prior development. For example, taking n=0, eliminates the series in z. We note that the coefficient automatically takes on ½ values by omitting the repetition of “±” when n=0. Thus, with n=0 (and z absent) in Equation (13), we get

$$( {I}_{XY} + {I}_{Y} ) \approx ( \frac{a}{{π}^{2} {Lk}_{x}} ) {\sum }_{m = 1}^{∞} cos ( \frac{π my}{b} ) ( {I}_{1} + {I}_{2} + {I}_{3} + {I}_{4} ) \qquad ( 25 )$$

or, in terms of the exponential functions used in Equations (20-24), with

$${F}_{1} ( x , {x}_{i} ; m , n ) ≡ \frac{{e}^{- π ( {x}_{i} + x ) \sqrt{\frac{{k}_{y} {m}^{2}}{{k}_{x} {b}^{2}} + \frac{{k}_{z} {n}^{2}}{{k}_{x} {h}^{2}}}}}{\sqrt{\frac{{k}_{y} {m}^{2}}{{k}_{x} {b}^{2}} + \frac{{k}_{z} {n}^{2}}{{k}_{x} {h}^{2}}}} , \\ {F}_{2} ( x , {x}_{i} ; m , n ) ≡ \frac{{e}^{- π [ 2 a - ( {x}_{i} + x ) ] \sqrt{\frac{{k}_{y} {m}^{2}}{{k}_{x} {b}^{2}} + \frac{{k}_{z} {n}^{2}}{{k}_{x} {h}^{2}}}}}{\sqrt{\frac{{k}_{y} {m}^{2}}{{k}_{x} {b}^{2}} + \frac{{k}_{z} {n}^{2}}{{k}_{x} {h}^{2}}}} , \\ {F}_{3} ( x , {x}_{i} ; m , n ) ≡ \frac{{e}^{- π \vert {x}_{i} - x \vert \sqrt{\frac{{k}_{y} {m}^{2}}{{k}_{x} {b}^{2}} + \frac{{k}_{z} {n}^{2}}{{k}_{x} {h}^{2}}}}}{\sqrt{\frac{{k}_{y} {m}^{2}}{{k}_{x} {b}^{2}} + \frac{{k}_{z} {n}^{2}}{{k}_{x} {h}^{2}}}} , and \\ {F}_{4} ( x , {x}_{i} ; m , n ) ≡ \frac{{e}^{- π ( 2 a - \vert {x}_{i} - x \vert ) \sqrt{\frac{{k}_{y} {m}^{2}}{{k}_{x} {b}^{2}} + \frac{{k}_{z} {n}^{2}}{{k}_{x} {h}^{2}}}}}{\sqrt{\frac{{k}_{y} {m}^{2}}{{k}_{x} {b}^{2}} + \frac{{k}_{z} {n}^{2}}{{k}_{x} {h}^{2}}}} , for i = 1 , 2 , \\ ( {I}_{XY} + {I}_{Y} ) \approx \frac{{ab}^{2}}{{π}^{2} L ( {α}^{2} {k}_{y} + {β}^{2} {k}_{x} )} \{ \begin{matrix}2 α \cdot H ( x - {x}_{1} ) \cdot H ( {x}_{2} - x ) \cdot {\sum }_{m = 1}^{∞} \frac{1}{{m}^{2}} cos ( \frac{π my}{b} ) \\ cos π ( \frac{m}{b} [ {y}_{1} + \frac{β}{α} ( x - {x}_{1} ) ] ) + {\sum }_{j = 1}^{4} {\sum }_{m = 1}^{∞} ( \frac{1}{{m}^{2}} ) \\ {F}_{j} ( x , {x}_{2} ; m , 0 ) cos ( \frac{π my}{b} ) \\ [ \begin{matrix}β \sqrt{\frac{{k}_{x}}{{k}_{y}}} \cdot \\ sin π ( \frac{{my}_{2}}{b} ) + \\ α \cdot {λ}_{j} ( x , {x}_{2} ) \cdot \\ cos π ( \frac{{my}_{2}}{b} )\end{matrix} ] - {\sum }_{j = 1}^{4} {\sum }_{m = 1}^{∞} ( \frac{1}{{m}^{2}} ) \\ {F}_{j} ( x , {x}_{1} ; m , 0 ) cos ( \frac{π my}{b} ) [ \begin{matrix}β \sqrt{\frac{{k}_{x}}{{k}_{y}}} \cdot \\ sin π ( \frac{{my}_{1}}{b} ) + \\ α \cdot {λ}_{j} ( x , {x}_{1} ) \cdot \\ cos π ( \frac{{my}_{1}}{b} )\end{matrix} ]\end{matrix} \} \qquad ( 26 )$$

where ξₖ was simplified by setting n=0, and

$$\begin{matrix}{λ}_{1} ( x , {x}_{i} ) = - 1 \\ {λ}_{2} ( x , {x}_{i} ) = 1 \\ {λ}_{3} ( x , {x}_{i} ) = sign ( x - {x}_{i} ) \\ {λ}_{4} ( x , {x}_{i} ) = sign ( {x}_{i} - x )\end{matrix} \} , i = 1 , 2 \qquad ( 27 )$$

We get an analogous expression for (I_{XZ}+I_{Z}). Thus, with m=0 (and y absent), in Equation (13)

$$( {I}_{XZ} + {I}_{Z} ) \approx \frac{{ah}^{2}}{{π}^{2} L ( {α}^{2} {k}_{z} + {γ}^{2} {k}_{x} )} \{ \begin{matrix}2 α \cdot H ( x - {x}_{1} ) \cdot H ( {x}_{2} - x ) \cdot {\sum }_{n = 1}^{∞} \frac{1}{{n}^{2}} cos ( \frac{π nz}{h} ) cos π ( \frac{n}{h} [ {z}_{1} + \frac{γ}{α} ( x - {x}_{1} ) ] ) + \\ {\sum }_{j = 1}^{4} {\sum }_{n = 1}^{∞} ( \frac{1}{{n}^{2}} ) {F}_{j} ( x , {x}_{2} ; 0 , n ) cos ( \frac{π nz}{n} ) [ \begin{matrix}γ \sqrt{\frac{{k}_{x}}{{k}_{z}}} \cdot sin π ( \frac{{nz}_{2}}{h} ) + \\ α \cdot {λ}_{j} ( x , {x}_{2} ) \cdot cos π ( \frac{{nz}_{2}}{h} )\end{matrix} ] - \\ {\sum }_{j = 1}^{4} {\sum }_{n = 1}^{∞} ( \frac{1}{{n}^{2}} ) {F}_{j} ( x , {x}_{1} ; 0 , n ) cos ( \frac{π nz}{h} ) [ \begin{matrix}γ \sqrt{\frac{{k}_{x}}{{k}_{z}}} \cdot sin π ( \frac{{nz}_{1}}{h} ) + \\ α \cdot {λ}_{j} ( x , {x}_{1} ) \cdot cos π ( \frac{{nz}_{1}}{h} )\end{matrix} ]\end{matrix} \} \qquad ( 28 )$$

where Fⱼs are as previously defined with m=0.
Note that the first sums of the RHS of Equations (26) and (28) admit polynomial formulas, recognizing

$$2 \cdot {\sum }_{n = 1}^{∞} \frac{cos ( π {nx}_{1} ) cos ( π {nx}_{2} )}{{n}^{2}} ≡ {π}^{2} [ \frac{1}{3} - max ( {x}_{1} , {x}_{2} ) + \frac{{x}_{1}^{2} + {x}_{2}^{2}}{2} ] . \qquad ( 29 )$$

### Integrated Single Infinite Series (I_{X})

The integration of single series solution, S_{X}, is straightforward.

$$\begin{matrix} {I}_{X} ≡ ( \frac{2 {a}^{2}}{{π}^{2} {Lk}_{x}} ) {\int }_{0}^{L} {\sum }_{l = 1}^{∞} \frac{cos ( \frac{π lx}{a} ) cos ( \frac{π l ( {x}_{1} + α s )}{a} )}{{l}^{2}} d s & ( 30 ) \\ {I}_{X} ≡ ( \frac{2 {a}^{2}}{{π}^{2} {Lk}_{x}} ) {\sum }_{l = 1}^{∞} \frac{cos ( \frac{π lx}{a} ) [ sin ( \frac{π {lx}_{2}}{a} ) - sin ( \frac{π {lx}_{1}}{a} ) ]}{\frac{πα {l}^{3}}{a}} & ( 31 ) \\ {I}_{X} ≡ ( \frac{{a}^{3}}{{π}^{3} α {Lk}_{x}} ) {\sum }_{l = 1}^{∞} \frac{sin [ \frac{π l}{a} ( {x}_{2} \pm x ) ] - sin [ \frac{π l}{a} ( {x}_{1} \pm x ) ]}{{l}^{3}} \\ Thus , & ( 32 ) \\ {I}_{X} ≡ ( \frac{{a}^{3}}{{π}^{3} α {Lk}_{x}} ) [ {F}_{3} ( \frac{{x}_{2} + x}{a} ) + {F}_{3} ( \frac{{x}_{2} - x}{a} ) - {F}_{3} ( \frac{{x}_{1} + x}{a} ) - {F}_{3} ( \frac{{x}_{1} - x}{a} ) ] \\ where & ( 33 ) \\ {F}_{3} ( z ) ≡ {\sum }_{n = 1}^{∞} \frac{sin ( π nz )}{{n}^{3}} ≡ {π}^{3} \cdot z \cdot [ \frac{1}{6} - \frac{\vert z \vert}{4} ( 1 - \frac{\vert z \vert}{3} ) ] , 0 \leq \vert z \vert \leq 2 & ( 34 )\end{matrix}$$

In summary, the pressure at an arbitrary observation point (x, y, z) in a sealed 3-D box with spatially invariant, but possibly anisotropic, permeability (kₓ, k_{y}, k_{z}) due to a line source segment of unit strength from (x₁, y₁, z₁) to (x₂, y₂, z₂) is given by Equation (9) and the combination of elements reduced to easily computable expressions represented by Equations (13, 20, 21, 22, 23, 24, 26, 28, 29, and 33). To illustrate, the dimensionless pressure distribution

$$\tilde{P} ( x , y , z ) ≡ \frac{( P ( x , y , z ) - \overline{P} ) abh}{4 π B μ q} ,$$

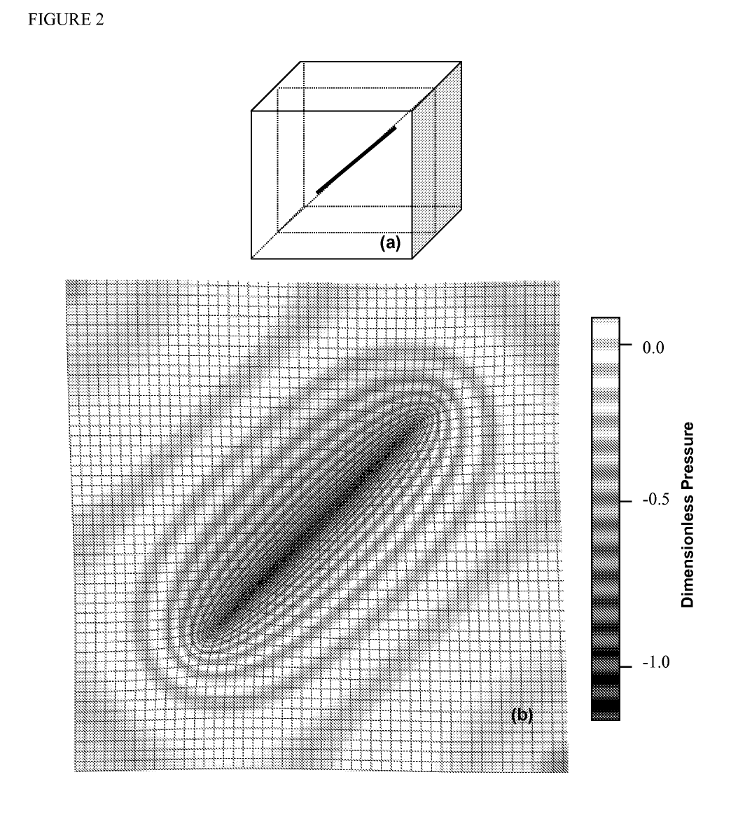

for the central XZ slice in the plane containing a well with endpoints (x₁, y₁, z₁)=(0.25, 0.5, 0.25) and (x₂, y₂, z₂)=(0.75, 0.5, 0.75) in a cube with isotropic permeability is shown in FIG. 2.

### Two Dimensional Application

The two-dimensional case is also of practical interest and is recognized as a contained embodiment of the above development. When the Neumann function for a point source is integrated along a linear segment in the XY plane (which constitutes a planar source in 3-D), we merely pick up a subset of the developed terms for three dimensions.

P(x,y;x₁,y₁,α,β,L)− P̅=C[(I_{XY}+I_{Y})+I_{X}] (35)

The 2-D result is particularly useful in modeling of fractured wells or inclined wells in thin reservoirs for dimensionless values of the ratio

$$( \frac{a}{h} \sqrt{\frac{{k}_{z}}{{k}_{x}}} )$$

exceeding 5.

### Well Pressure and Well Productivity

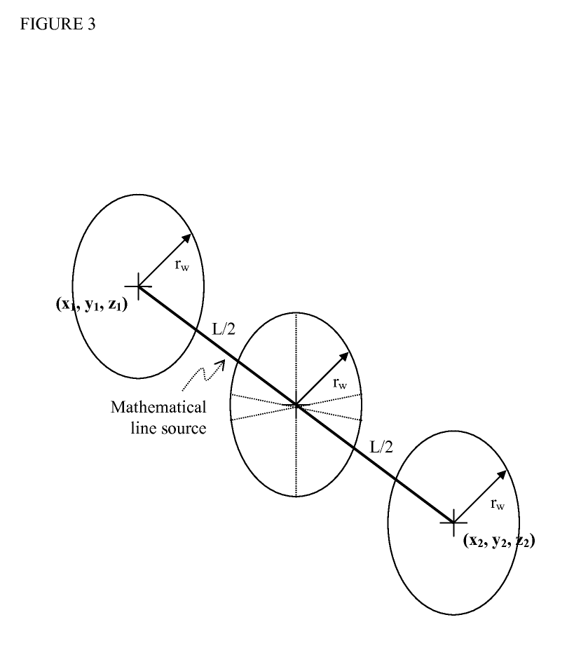

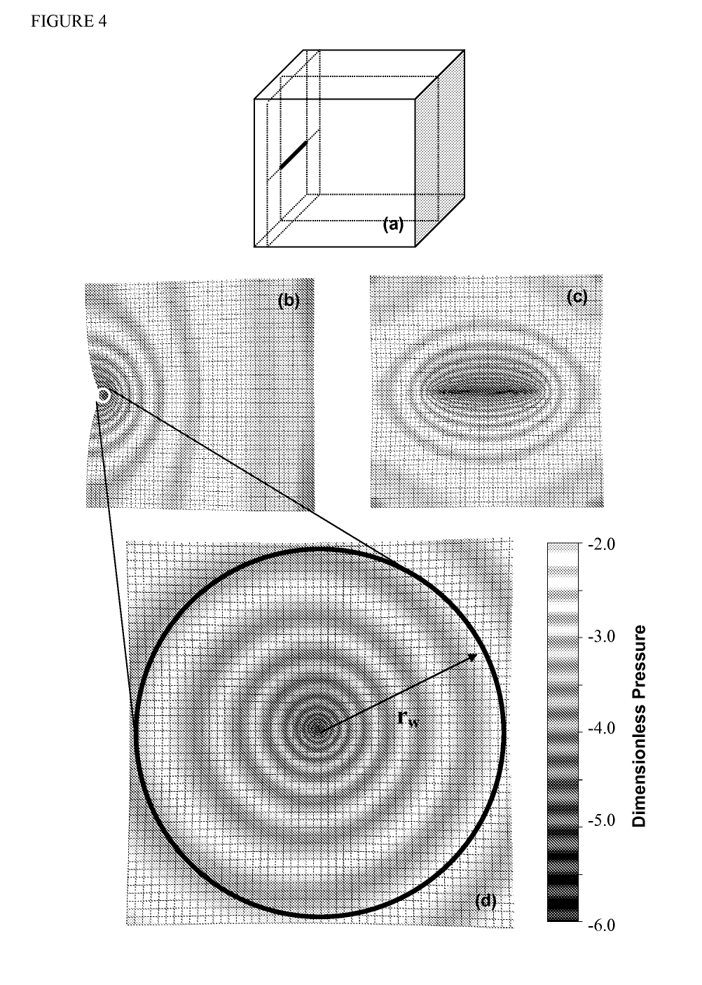

The cited model equations have been coded into a software package and reduced to practice. Of particular interest is the observation point a distance r_{w}, the well radius, from the mathematical line sink. Of historical interest has been the value at the midpoint of the well (see FIG. 3), though the method allows for pressure determination at any specified point or sets of points. The determination of the pressure observable at a well location in this manner has been reduced to practice. In FIG. 4, we see the pressure distribution for a partially penetrating horizontal well near one of the boundaries and an exploded view of the pressure distribution in the area immediately surrounding the mathematical line source for the plane normal to the well passing through the well midpoint. For the line source with endpoints (x₁, y₁, z₁) and (x₂, y₂, z₂) and direction cosines (α, β, γ), the plane normal to the line passing through the midpoints,

$$( {x}_{m} , {y}_{m} , {z}_{m} ) ≡ ( \frac{{x}_{1} + {x}_{2}}{2} , \frac{{y}_{1} + {y}_{2}}{2} , \frac{{z}_{1} + {z}_{2}}{2} ) ,$$

is represented by the equation

α(x−xₘ)+β(y−yₘ)+γ(z−zₘ)=0 (36)

Points on this plane a radial distance equal to the well radius, r_{w}, from the midpoint are given by

(x−xₘ)²+(y−yₘ)²+(z−zₘ)²=r_{w}² (37)

In one embodiment of this invention, we take a limited number of such points, setting successively x=xₘ, y=yₘ, and z=zₘ, yielding the observation points

$$( {x}_{m} , {y}_{m} ∓ \frac{γ {r}_{w}}{\sqrt{{β}^{2} + {γ}^{2}}} , {z}_{m} \pm \frac{β {r}_{w}}{\sqrt{{β}^{2} + {γ}^{2}}} ) \\ ( {x}_{m} ∓ \frac{γ {r}_{w}}{\sqrt{{α}^{2} + {γ}^{2}}} , {y}_{m} , {z}_{m} \pm \frac{α {r}_{w}}{\sqrt{{α}^{2} + {γ}^{2}}} ) \\ ( {x}_{m} ∓ \frac{β {r}_{w}}{\sqrt{{α}^{2} + {β}^{2}}} , {y}_{m} \pm \frac{α {r}_{w}}{\sqrt{{α}^{2} + {β}^{2}}} , {z}_{m} ) \qquad ( 38 )$$

We recommend taking an average of unique observation points for each segment and averaging those, if desired, to get an overall representative average for a well composed of multiple segments.

### Advanced Well Designs

A well trajectory can be approximated by any number of linear segments. By the superposition principle, the effects of all such line source segments on the pressure at an observation point (x, y, z) are additive. Thus, for any number of line source segments, N_{seg}, within the box, we can write the expression for pressure as

$$P ( x , y , z ; {x}_{1 i} , {y}_{1 i} , {z}_{1 i} ; {α}_{i} , {β}_{i} , {γ}_{i} ; {L}_{i} , i = 1 , {N}_{seg} ) - \overline{P} = {\sum }_{i = 1}^{Nseg} {C}_{i} [ \begin{matrix}( {I}_{{XYZ}_{i}} + {I}_{{YZ}_{i}} ) + \\ ( {I}_{{XZ}_{i}} + {I}_{{Z}_{i}} ) + ( {I}_{{XY}_{i}} + {I}_{{Y}_{i}} ) + {I}_{{X}_{i}}\end{matrix} ] \qquad ( 39 )$$

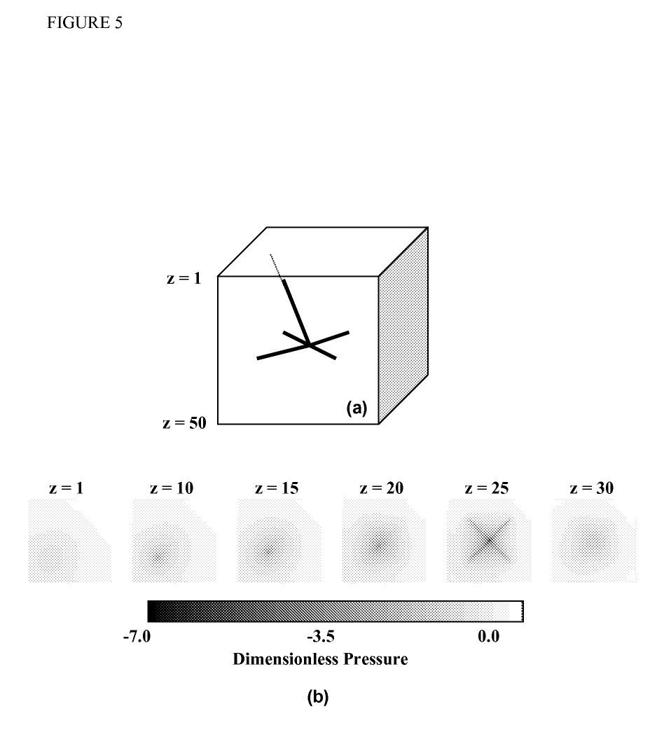

The method where multiple line segments approximate an arbitrary wellbore trajectory and act in unison to determine the pressure distribution has been reduced to practice. In FIG. 5, we see the dimensionless pressure for different XY slices through a three-dimensional cube of isotropic permeability with a partially penetrating motherbore and four lateral wellbores as illustrated. The fractional length of the line segment in comparison with the total well length is an appropriate weighting factor for this uniform flux approach.

### Infinite and Finite Conductivity Wells

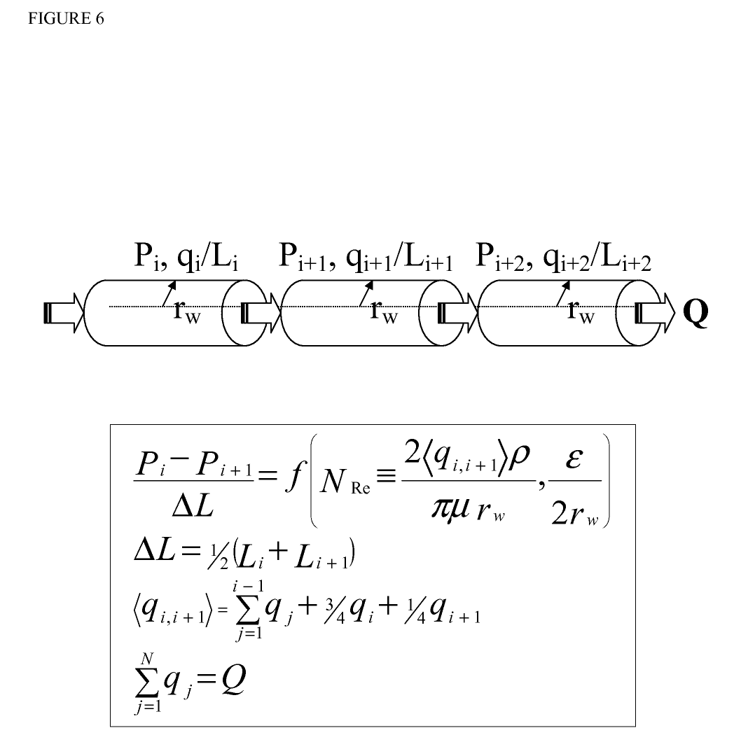

The segmented well can be further modified to describe the case where pressure rather than flux is specified. Using a constitutive relationship between pressure drop and flow rate within a well, one can pose and solve a set of equations to describe the pressure distribution along a well with unknown segment flux but known overall production rate, as illustrated in FIG. 6. The problem could likewise be posed with a pressure constraint, such as a pump mechanical limit, and unknown overall flux. The so-called infinite conductivity well (uniform pressure) is a special case of this algorithm where pressure is unknown but uniform along the well. An expression for pressure difference between adjacent segments, along with the overall material balance for the well, closes the system of equations.

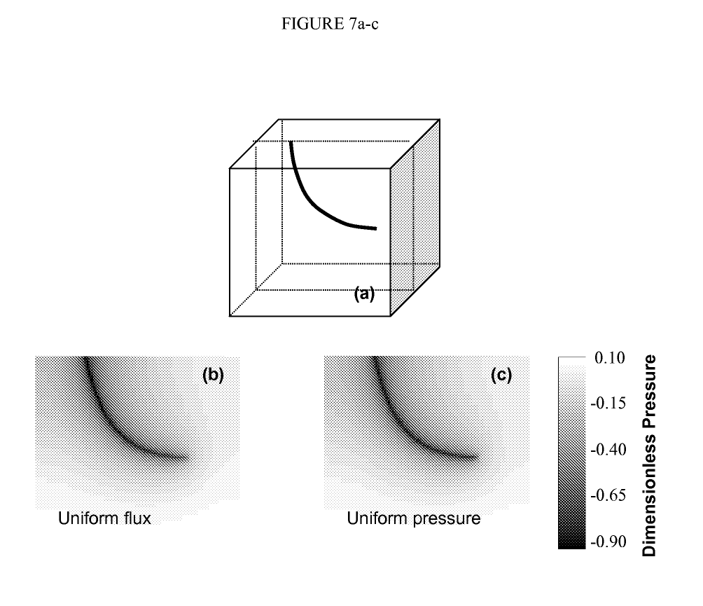

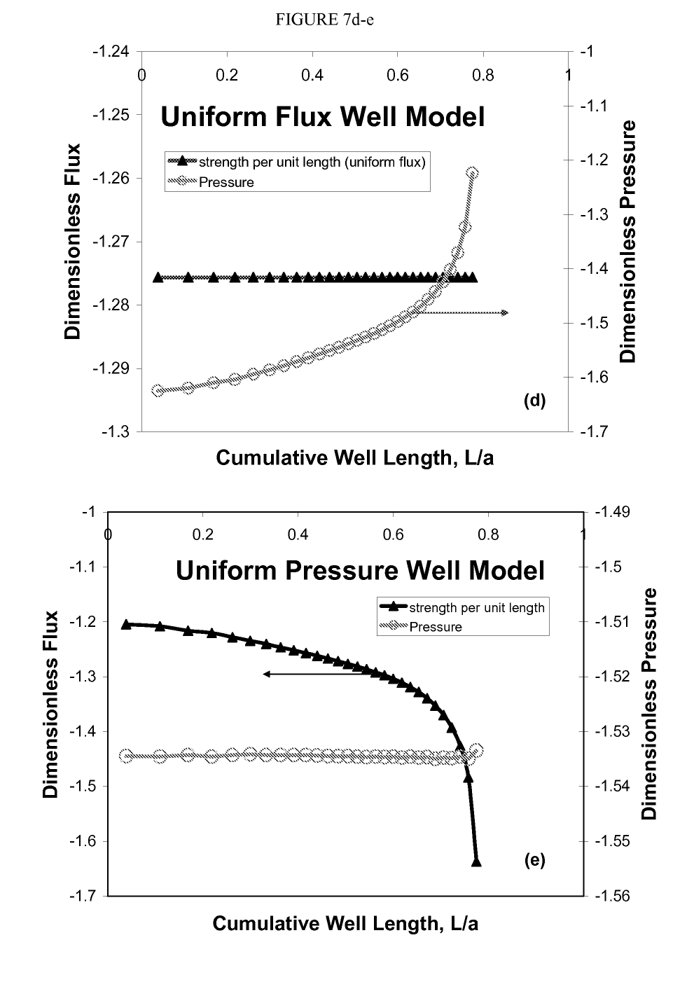

Alternatively, uniform pressure cases can be readily evaluated using a direct iterative procedure. A uniform flux initial guess returns the productivity index for each segment. The reciprocal of the computed productivity index is normalized and used as the updated flux. The process is repeated until convergence. Multiple passes are required only to account for well interference effects. The described iterative procedure has been reduced to practice in software to give the flux in each well segment. The solver can likewise be bypassed in finite conductivity well cases by computing a productivity index for each segment with a uniform flux initial guess, computing the flux required to give the specified pressure drop along the well segment using a constitutive equation, such as that for pipe flow using friction factor concepts, and repeating the process until convergence. FIG. 7 illustrates the difference between these two cases with the same curvilinear well trajectory decomposed into 29 piecewise linear segments. FIG. 7a shows the dimensionless pressure distribution for the central plane containing the well with identical flux per unit length. FIG. 7b shows the dimensionless pressure for the same slice and same well trajectory after the iterative procedure to yield equal pressure at each segment midpoint with adjustment of flux. The pressure and flux distributions for these two cases are presented in FIGS. 7c & 7d.

### Generalization to Open Systems

The Neumann function solution can be further generalized to include material transport at the faces of the rectangular cell using Green's Theorem. In this method, the equation becomes

$$P ( \vec{x} ) = \overline{P} - ( \frac{1}{{q}_{o}} ) \cdot {\sum }_{i} {q}_{wi} \cdot {N}_{L} ( \vec{x} , {\vec{x}}_{1 i} , {\vec{x}}_{2 i} ) - ( \frac{1}{{q}_{o}} ) {\int }_{S} {N}_{o} ( \vec{x} , σ ) g ( σ ) d σ \qquad ( 40 )$$

where \vec{x} is the observation point location, qₒ is a reference production rate, q_{wi} is the production rate for segment i, N_{L} are the Neumann functions for the linear segments (\vec{x}_{L},\vec{x}₂ᵢ), and the product of the normal flux, g(σ), and point source Neumann function, Nₒ, is integrated over open boundary surfaces, S. Equation (40) is especially relevant for the choice of observation point for well pressure characterization, \vec{r}_{w}. If all six faces were open for material transport, the integration would be broken into six separate integrations, one for each face. Partial integrations are allowed with the flux defined to be zero (and hence noncontributing) on closed portions of the boundary. The integrations in Equation (40) can be estimated numerically by any one of a variety of standard techniques, such as Gaussian quadrature or the trapezoidal rule. In this fashion, pressure support to the cell by water influx is accommodated. Flux can be easily included from any of the faces to model physical cases. In this invention, the fast computing Equation (9) is used for N_{L}.

In the limit of strong aquifer support, the pressure at the boundary remains constant, as water is supplied to fully account for fluid withdrawn from the cell via the well. In the strong aquifer limit, the Green's function is recommended over the Neumann function. The derivation is repeated for the analogous case with Sine functions in place of Cosines in Equations (6), (7), and (8).

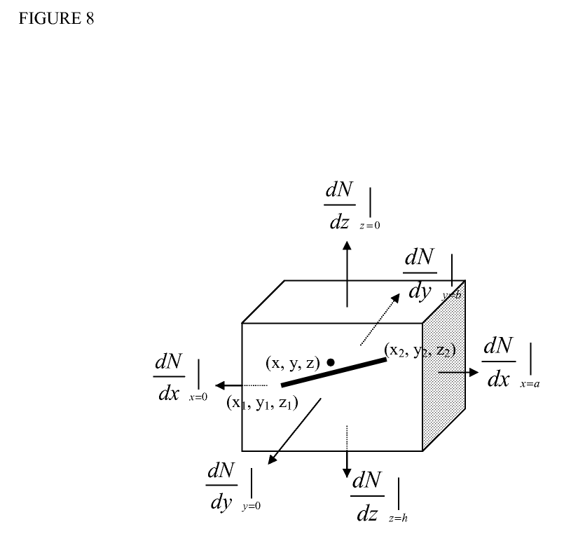

An important special case is that where the flux is presumed to be uniformly distributed across a fully open face. In traditional numerical reservoir simulators, only a single value of flux is associated with each planar interface of adjoining cells, as illustrated in FIG. 8. In the absence of a detailed flux distribution pattern, a uniform flux distribution allows analytic reduction of the integral in Equation (40). For example, replacing the normal flux with a representative average value, [symbol] g [symbol] ,

$$\begin{matrix}〈 g 〉 {\int }_{0}^{b} {\int }_{0}^{h} {N}_{o} ( x , y , z ; {x}_{o} = 0 , {y}_{o} , {z}_{o} ) d {y}_{o} d {z}_{o} \\ = \frac{〈 g 〉}{bh} ( \frac{2 {a}^{2}}{{π}^{2} {k}_{x}} ) {\int }_{0}^{b} {\int }_{0}^{h} {\sum }_{l = 1}^{∞} \\ \frac{cos ( \frac{π lx}{a} )}{{l}^{2}} d {y}_{o} d {z}_{o} \\ = 〈 g 〉 ( \frac{2 {a}^{2}}{{k}_{x}} ) [ \frac{1}{6} - \frac{x}{2 a} + {( \frac{x}{2 a} )}^{2} ]\end{matrix} \qquad ( 41 )$$

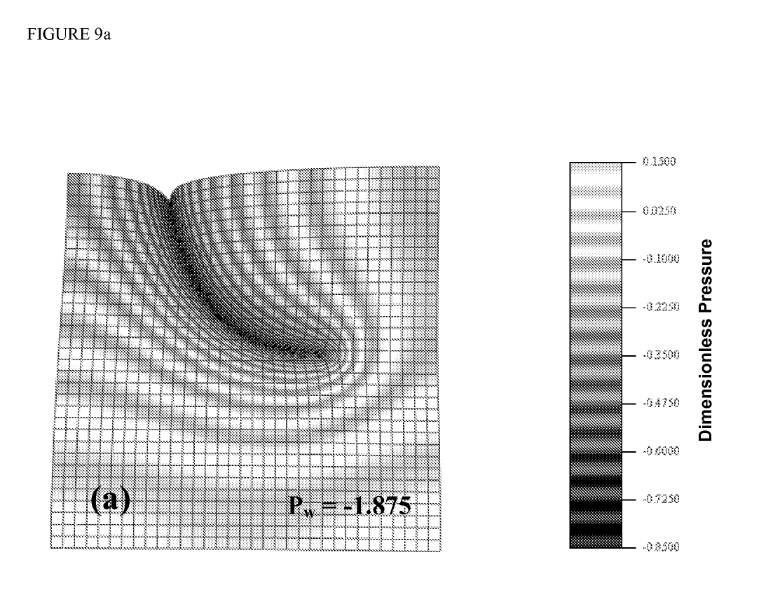

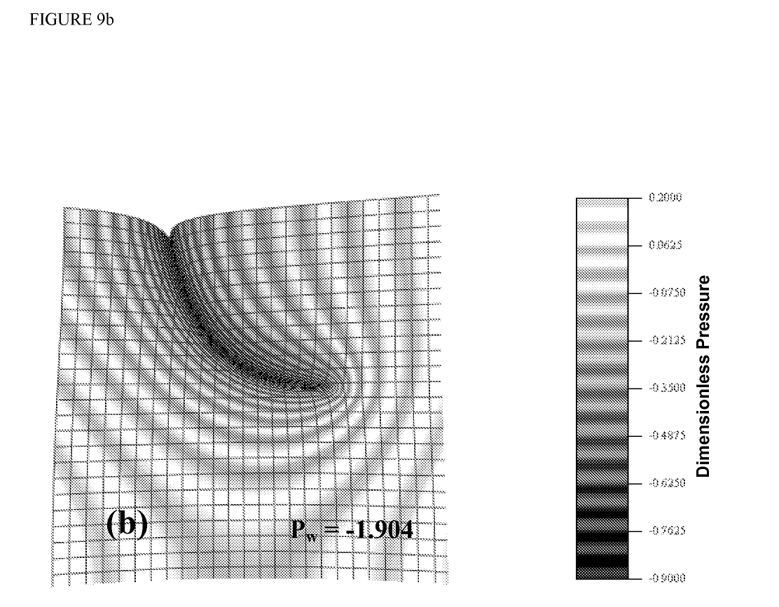

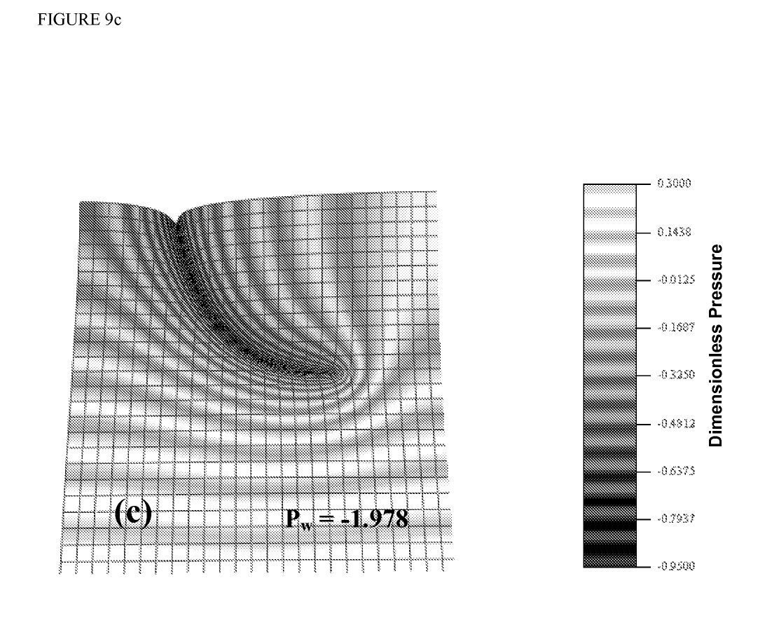

Similar expressions apply for the other five faces with switch of variables and the dummy variable, x, representing the normal distance to the face over which the Neumann function is integrated. FIG. 9 shows the pressure distribution across the central slice containing the well for the uniform pressure case developed in FIG. 7 for three external boundary situations: (a) sealed boundaries, (b) open lateral boundaries, and (c) influx from the bottom face. The well pressure is sensitive to the boundary conditions imposed, as boundaries strongly influence the direction and convergent nature of fluid flow towards wellbores. The observed flow weighted average well pressures are given as insets for the three boundary condition cases of FIG. 9. Sensitivity to the integrity of external boundaries is anticipated to heighten between multiple wellbores, e.g. well interference tests.

Of particular commercial interest is when the rectangular cell is a well block within a numerical reservoir simulation. The invention can then be used to describe well productivity (the relationship between pressure and production rate) for any complex well trajectory or wellbore cluster below the resolution of the simulation. The invention can be used for explicit computation of well properties or as feedback for an ongoing numerical simulation as a constraint on the pressure or total flux for the well block.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention. For example, time-dependent character has been excluded here since historically well equations have been constructed for the pseudo-steady state regime. Time dependency is easily reintroduced, as shown in Jasti et al. (1999), since singularities occur in space rather than time. Thus, inclusion of temporal extension of the embodiment is considered from a patent standpoint as logical and obvious. Likewise, potential and pressure have been used interchangeably in the development herein. The solutions are actually in terms of potential, with pressure being the commonly measured property. Potentials are routinely converted to pressures, as any skilled in the art would know, with the inclusion of gravitational forces. This is particularly relevant to pressure relationships for flow within a non-horizontal wellbore where gravitational head is an important contribution to the driving force for flow.

### NOTE on Special Limiting Cases (Wells Parallel to Coordinate Axes)

When the wells are oriented strictly parallel to one of the coordinate axes (horizontal and vertical wells), two of the direction cosines (α, β, γ) become zero. In such limiting cases, Equations (26, 28, and 33) will present computing and coding challenges. By a proper grouping of the terms, and some algebraic simplifications, the relevant computations can be handled. Slow convergence rates often are the challenge in these limiting cases. Alternately, direct methods based upon components from published literature are available to address such simpler version of the general problem (Gradshteyn and Rhyzik, 1980; Muskat, 1949; Babu and Odeh, 1989). For example, consider the following infinite series Bessel function solution to the Laplace Equation given by Muskat (1949, p. 208).

$$Pressure \sim 2 {\sum }_{n = 1}^{∞} {K}_{o} ( \frac{π nr}{h} ) \cdot cos ( \frac{π nz}{h} ) cos ( \frac{π {nz}_{o}}{h} ) + ln ( \frac{4 h}{r} ) , \\ 0 < r < ∞ , 0 \leq z \leq h , \\ 0 \leq {z}_{o} \leq h \qquad ( 42 )$$

This equation describes fluid flow due to a point sink/source at (r=0, z=z₀) in a slab-like reservoir of thickness h, extending laterally to infinity, and with impermeable top and bottom boundaries (z=0, z=h). The convergence of the series in Eq (42) is extremely fast, and in most cases, only a few terms of the series are needed to achieve highly accurate results.

Integration with respect to z₀, from z₁ to z₂, solves the problem of a partially penetrating vertical well. Problems of partially penetrating wells in rectangular box-shaped (bounded) reservoirs can be addressed by summing up all reflections of K₀ across the sides of the rectangle. Change of variables, between (x, y, z), will solve problems of horizontal wells parallel to coordinate axes.

Next, to deal with small magnitudes of the variables (r/h) or (z/h), in Eq (42), the following expansions are available (Gradshteyn and Rhyzik, 1980).

$${\sum }_{n = 1}^{∞} {K}_{o} ( π nX ) \cdot cos ( π nZ ) = \frac{1}{2} [ \begin{matrix}0.5772 + ln ( \frac{X}{4} ) + \frac{1}{\sqrt{{X}^{2} + {Z}^{2}}} + \\ {\sum }_{l = 1}^{∞} ( \frac{1}{\sqrt{{X}^{2} + {( 2 l - Z )}^{2}}} + \frac{1}{\sqrt{{X}^{2} + {( 2 l + Z )}^{2}}} - \frac{1}{l} )\end{matrix} ] \qquad ( 43 )$$

For fast computations involving Equations (26) and (28) in the case of degenerate (limiting) versions of the general problem, the following formulas facilitate switching between the two types of series: Eq (42) in K₀, and the trigonometric series of Eqs (26) and (28). To separate variables α and β, use the integral (Gradshteyn and Rhyzik, 1980, p. 732)

$${\int }_{0}^{∞} {K}_{o} ( πα t ) \cdot cos ( πβ t ) d t = \frac{1}{2 \sqrt{{α}^{2} + {β}^{2}}} . \qquad ( 44 )$$

In summing series that converge extremely slowly, we use the spectral representation of the Dirac Delta function, in conjunction with Eq (44), and subsequently achieve rapid convergence rates.

$$1 + 2 \cdot {\sum }_{m = 1}^{∞} cos ( \frac{π mt}{a} ) \cdot cos ( \frac{π mx}{a} ) = a \cdot {\sum }_{l = 0}^{∞} δ [ t - ( 2 al \pm x ) ] , \\ for 0 \leq x \leq a , 0 < t < ∞ \qquad ( 45 )$$

While elements leading to fast converging formulas for pressure computation in special case well orientations exist in the public domain, we incorporate the method of using these identities in tandem as a preferred embodiment of handling also the special cases as limiting simplified versions of this invention.

What is claimed is:

1. A rapid method to compute the pressure, including that observable at the wellbore radius, in a subterranean fluid reservoir with spatially invariant, anisotropic transport properties, in response to specified injection or production through one or more wells, using readily computable Green's or Neumann functions that have been integrated along a linear well path in arbitrary three-dimensional orientation within a rectangular, box-shaped cell.

2. The method cited in claim 1 to model productivity of wells of arbitrary trajectory using superposition and a piece-wise linear approximation to the well path.

3. The method in claim 1 within a system to model heterogeneous reservoirs using boundary integral methods to impose continuity of pressure and flux across locally homogeneous, anisotropic cells comprising the mathematical description of the heterogeneous reservoir.

4. The method in claim 1 which confines computations locally to only those cells intersected by wellbores within a system to relate the observable wellbore pressure and the properties on a grid in numerical simulation of fluid flow.

5. The method in claim 1 in which time is added in an iterative procedure to model well response during the transient period.

6. The method in claim 1 applied to two-dimensional problems, as simplified versions of 3D cases in which the integration is along an arbitrarily-oriented line, suitable for modeling a fractured well or a horizontal well in a sufficiently thin reservoir.

7. A rapid method to compute the pressure, including that observable at the wellbore radius, in a subterranean fluid reservoir with spatially invariant, anisotropic transport properties, in response to specified overall injection or production through one or more wells, using readily computable Green's or Neumann functions that have been integrated along two or more linear well path segments in arbitrary three-dimensional orientation within a rectangular, box-shaped cell, which honors a constitutive relationship describing the pressure drop response to volumetric flow in the interior of the wellbore.

8. The method cited in claim 7 to model productivity of wells of arbitrary trajectory using superposition and a piece-wise linear approximation to the well path.

9. The method in claim 7 within a system to model heterogeneous reservoirs using boundary integral methods to impose continuity of pressure and flux across locally homogeneous, anisotropic cells comprising the mathematical description of the heterogeneous reservoir.

10. The method in claim 7 which confines computations locally to only those cells intersected by wellbores within a system to relate the observable wellbore pressure and the properties on a grid in numerical simulation of fluid flow.

11. The method in claim 7 in which time is added in an iterative procedure to model well response during the transient period.

12. The method in claim 7 applied to two-dimensional problems, as simplified versions of 3D cases in which the integration is along an arbitrarily-oriented line, suitable for modeling a fractured well or a horizontal well in a sufficiently thin reservoir.

13. A method in which the computed pressure at the well radius is used as feedback in a numerical simulation of fluid flow in a subterranean fluid reservoir to limit or control flux for those cells intersected by wellbores using readily computable Green's or Neumann functions that have been integrated along one or more linear well path segments in arbitrary three-dimensional orientation within a rectangular, box-shaped cell.

14. The method in claim 13 in which the flux distribution along two or more segments honors a constitutive relationship describing the pressure drop response to volumetric flow inside the well.

15. The method in claim 13 in which time is added in an iterative procedure to model well response during the transient period.

16. The method in claim 13 applied to two-dimensional problems, as simplified versions of 3D cases in which the integration is along an arbitrarily-oriented line, suitable for modeling a fractured well or a horizontal well in a sufficiently thin reservoir.
